(19) United States
(12) Patent Application Publication
(10) Pub. No.: US 2010/0031687 A1
(43) Pub. Date: Feb. 11, 2010

(54) Conduit Joint for a Refrigerant Charging Device

(76) Inventor: Chia-Jen Lee, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/185,960

(22) Filed: Aug. 5, 2008

(51) Int. Cl. F25B 45/00; F16L 55/00

(52) U.S. Cl. 62/292; 285/80

(57) ABSTRACT

A conduit joint for a refrigerant charging device comprises an upper housing including a connection tube disposed on the outer wall thereof and a first chamber formed therein, a conduit connected between the connection tube and an outlet, a first compression spring mounted in the fist chamber; a lower housing fitted on the upper housing and including a second chamber fixed therein for communicating with the first chamber and balls retained on the outer wall thereof; a leakproof ring disposed in the second chamber and on the valve stem; an action loop mounted in the second chamber and under the leakproof ring, wherein the action loop pushes the balls outward by using the leakproof ring; an outer cover fitted around the lower housing, between the outer cover and the lower housing is defined a second compression spring, wherein the outer cover is pushed to move upward by the balls.

### BACKGROUND OF THE INVENTION

1. Field of the Invention

The present invention relates to a conduit joint for a refrigerant charging device that can feed the refrigerant into the air conditioning system from the refrigerant feeding end without leak.

2. Description of the Prior Art

U.S. Pat. No. 6,385,986 discloses a refrigerant charging hose assembly including an aerosol shut-off valve connectable to a refrigerant canister and interconnected to a disconnect coupler fitting by a length of refrigerant charging hose, the body portion of the coupler fitting being economically formed from high tensile strength elastomeric plastic material. A spring-loaded, floatingly supported control pin member is shifted to open the disconnect coupler fitting when the pin member engages and depresses a corresponding pin member within an air conditioning system service fitting to which the coupler fitting is connected. When the coupler fitting is removed from the service fitting the coupler fitting pin member is spring-driven back to its original position in which a flange portion thereof closes the coupler fitting to prevent discharge of pressurized refrigerant therethrough from the canister.

However, such a conventional refrigerant charging hose assembly has to be operated by hands, causing a tedious operation.

The present invention has arisen to mitigate and/or obviate the afore-described disadvantages.

### SUMMARY OF THE INVENTION

The primary objective of the present invention is to provide a conduit joint for a refrigerant charging device that can feed the refrigerant into the air conditioning system from the refrigerant feeding end without leak.

Another objective of the present invention is to provide a conduit joint for a refrigerant charging device that can be operated easily.

A conduit joint for a refrigerant charging device comprises an upper housing including a connection tube disposed on the outer wall thereof and extending outward, and a first chamber formed therein, a conduit connected between the connection tube and an outlet of the refrigerant charging device, and a first compression spring mounted in the fist chamber and its outer end being fitted into a valve stem;

a lower housing fitted on the bottom of the upper housing and including a second chamber fixed therein for communicating with the first chamber, and including a plurality of balls retained on the outer wall thereof;

a leakproof ring disposed in the second chamber of the lower housing and on the valve stem;

an action loop mounted in the second chamber and under the leakproof ring, wherein the action loop allows to push the balls outward by way of the leakproof ring;

an outer cover fitted around the lower housing, and between the outer cover and the lower housing is defined a second compression spring, wherein the outer cover is pushed to move upward due to the balls moves outwardly.

The various objects and advantages of the present invention will be more readily understood from the following detailed description when read in conjunction with the appended drawing.

### BRIEF DESCRIPTION OF THE DRAWINGS

FIG. 1 is a plane view illustrating a conduit joint for a refrigerant charging device of the present invention has not been fitted to an refrigerant feeding end;

FIG. 2 is a cross sectional view illustrating the conduit joint for the refrigerant charging device of the present invention has not been fitted to an refrigerant feeding end;

FIG. 3 is a cross sectional view illustrating the conduit joint for the refrigerant charging device of the present invention has been fitted to an refrigerant feeding end;

FIG. 4 is an amplified view of the part A of FIG. 3;

FIG. 5 is a cross sectional view illustrating the operation of the conduit joint for the refrigerant charging device in accordance with the present invention; and

FIG. 6 is an amplified view of the part B of FIG. 5.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

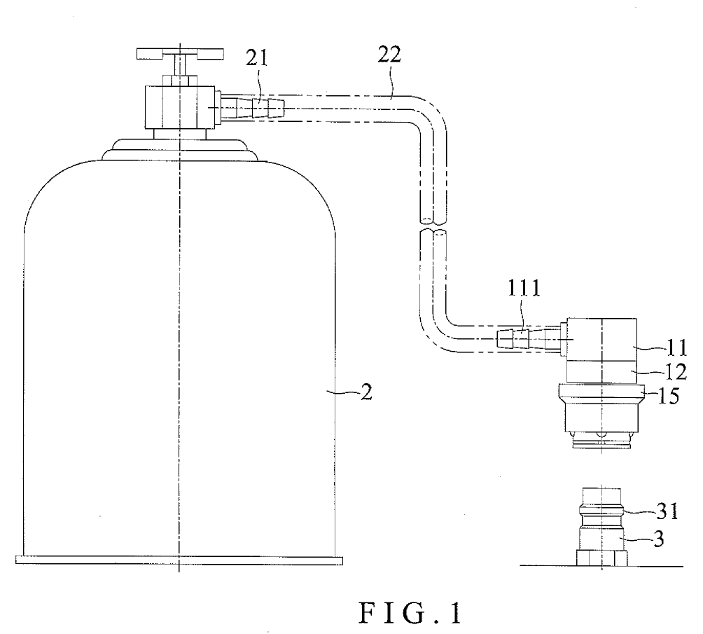

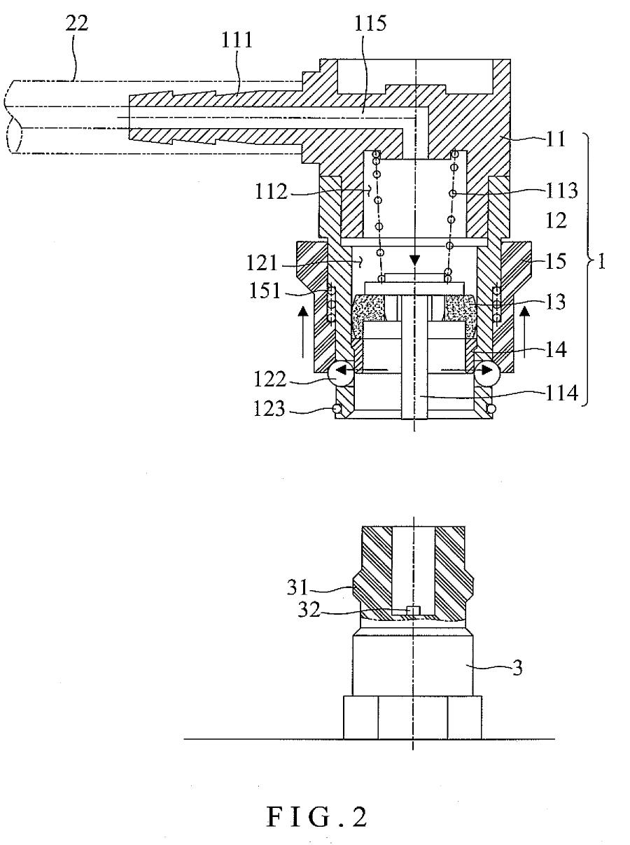

Referring to FIGS. 1 and 2, a conduit joint 1 for a refrigerant charging device 2 in accordance with the present invention comprises an upper housing 11, a lower housing 12, a leakproof ring 13, an action loop 14, and an outer cover 15.

The upper housing 11 includes a connection tube 111 disposed on the outer wall thereof and extending outward, and a first chamber 112 formed therein, a conduit 22 (as shown in FIG. 2) is connected between the connection tube 111 and an outlet 21 of the refrigerant charging device 2, and a first compression spring 113 is mounted in the fist chamber 112 and its outer end is fitted into a valve stem 114, wherein a passage 115 is arranged in the upper housing 11 and the connection tube 111.

The lower housing 12 is fitted on the bottom of the upper housing 11, and includes a second chamber 121 fixed therein for communicating with the first chamber 112, and includes a plurality of balls 122 retained on the outer wall thereof and equidistantly spaced apart from each other, wherein on the outer wall of the lower housing 12 where is located under the balls 122 is attached a C-ring 123, outer diameter of which extends out of the outer wall of the lower housing 12.

The leakproof ring 13 is disposed in the second chamber 121 of the lower housing 12 and on the valve stem 114, wherein the valve stem 114 is pushed to close the leakproof ring 13 by the first compression spring 113, preventing the leak of refrigerant.

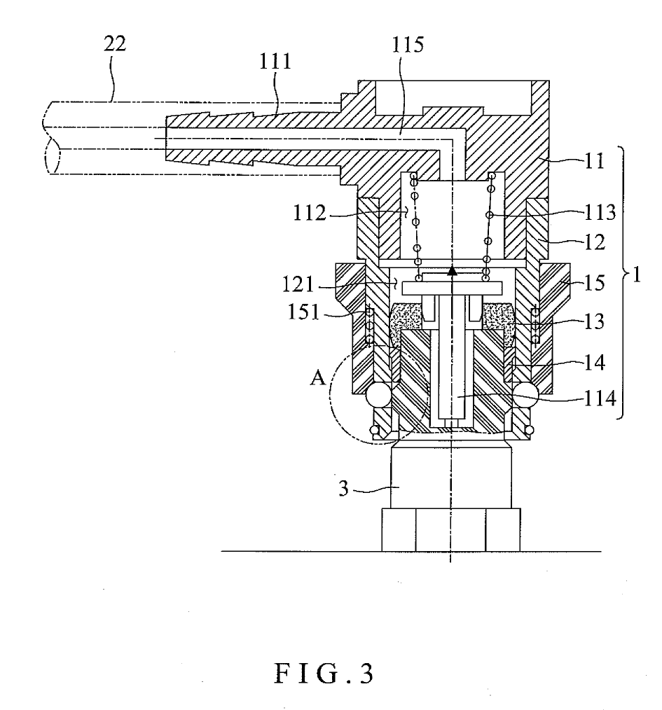

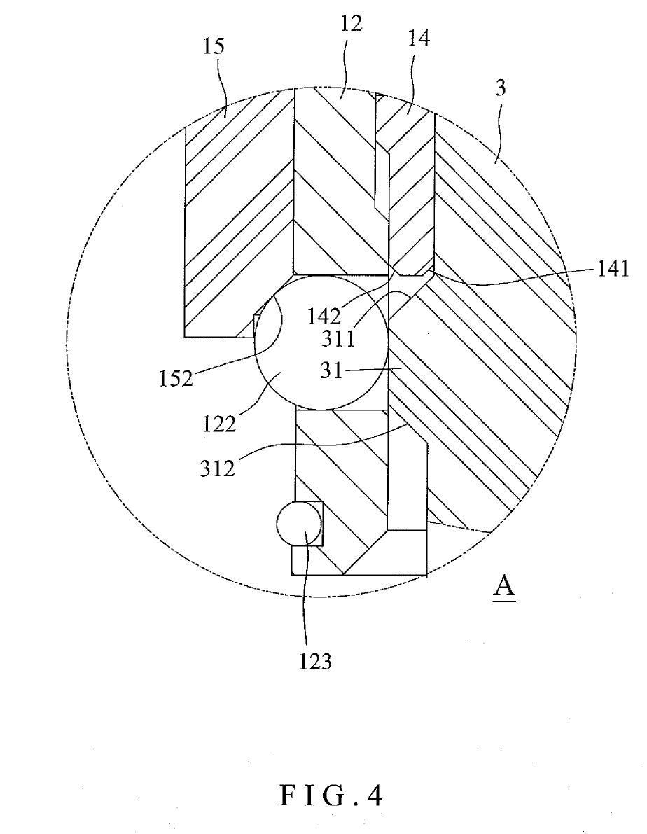

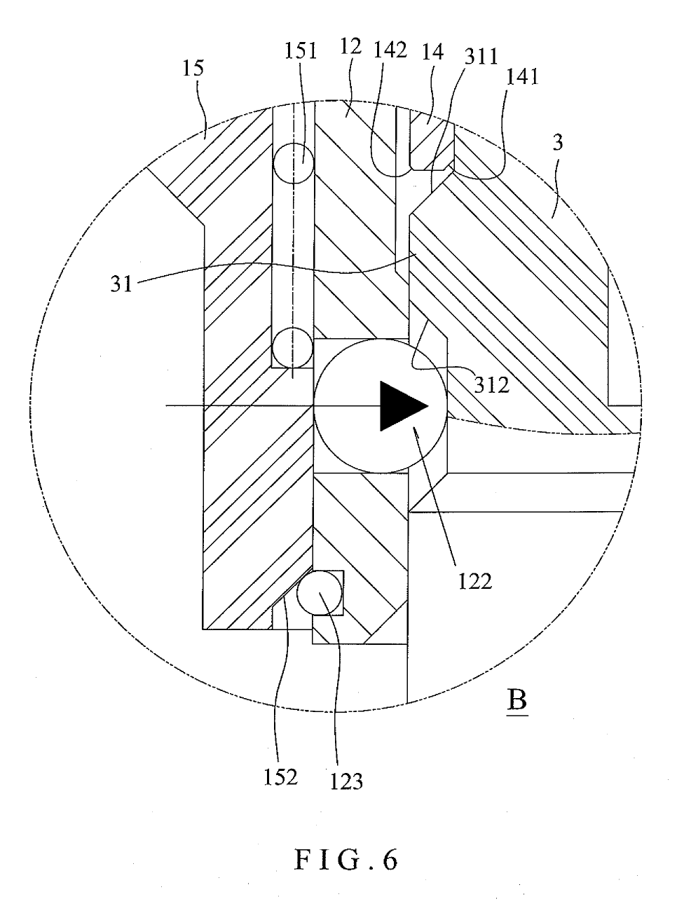

The action loop 14 is mounted in the second chamber 121 and under the leakproof ring 13 and allows to push the balls 122 outward by way of the leakproof ring 13, wherein as the conduit joint 1 contacts with a refrigerant feeding end 3, the action loop 14 is pushed by the refrigerant feeding end 3 to actuate the leakproof ring 13 to move upward in the first chamber 112 (as shown in FIGS. 3 and 4). On the inner and outer walls of the bottom of the action loop 14 are formed a first chamfer 141 and a second chamfer 142 respectively (as illustrated in FIGS. 4 and 6).

The outer cover 15 is fitted around the lower housing 12, and between the outer cover 15 and the lower housing 12 is defined a second compression spring 151, wherein the outer cover 15 is pushed to move upward due to the balls 122 moves outwardly and then the outer cover 15 compresses the second compression spring 151 upward as shown in FIG. 2, wherein on the inner wall of the bottom of the outer cover 15 is disposed a third chamfer 152 (as shown in FIGS. 4 and 6).

On the outer diameter of the refrigerant feeding end 3 is arranged a bulge loop 31 with a fourth chamfer 311 and a fourth chamfer 312 (as illustrated on FIGS. 4 and 6), and the outer diameter of the refrigerant feeding end 3 is less than that of the action loop 14, and in the refrigerant feeding end 3 in response to the end portion of the valve stem 114 is formed an inlet 32 (as illustrated in FIG. 2).

As the conduit joint 1 is fitted to the refrigerant feeding end 3, the outer diameter of the refrigerant feeding end 3 is engaged in the second chamber 121 so that the refrigerant feeding end 3 pushes the action loop 14 and the leakproof ring 13 to move inward simultaneously, and as the inlet 32 contacts with the end portion of the valve stem 114, the valve stem 114 is pushed to disengage from the leakproof ring 13.

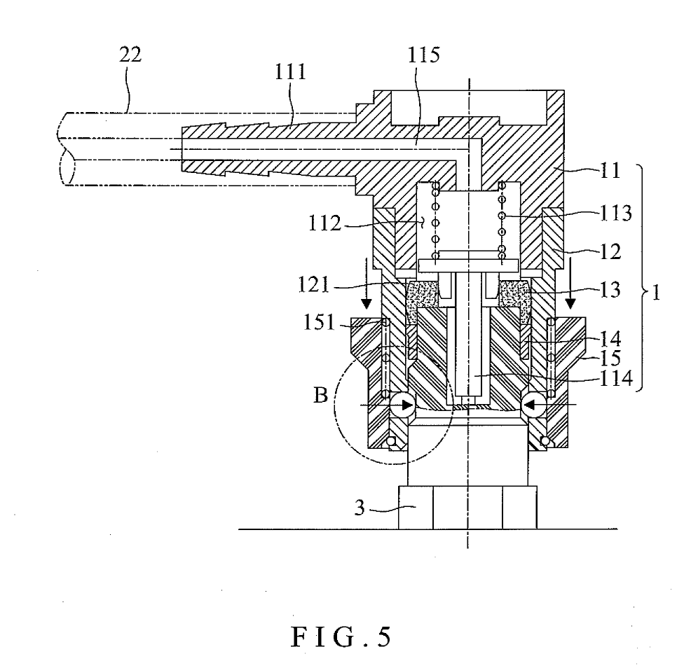

While the bulge loop 31 of the refrigerant feeding end 3 in the second chamber 121 moves across the balls 122 (as illustrated in FIGS. 5 and 6), the outer cover 15 moves toward the outer end of the lower housing 12 by using the second compression spring 151 at the time that the inner diameter of the outer cover 15 pushes the balls 122 to move inward so that the balls 122 are in response to the bulge loop 31, such that the third chamfer 152 of the outer cover 15 is limited by the C-ring 123 to stop downward movement of the outer cover 15, and the refrigerant feeding end 3 can not disengage from the lower housing 12 by means of the balls 122.

After the connection of the refrigerant feeding end 3 and the lower housing 12, the refrigerant in the refrigerant feeding end 3 is fed into the inlet 32 of the refrigerant feeding end 3 through the conduit 22, the passage 115 of the connection tube 111, and the clearance between the valve stem 114 and the leakproof ring 13 in turn.

On the contrary, as the conduit joint 1 disengages from the refrigerant feeding end 3, the outer cover 15 is pulled upward, moving the conduit joint 1 upward, and the inner diameter of the outer cover 15 pushes the balls 122 to move inward, disengaging from the outer cover 15. As the refrigerant feeding end 3 completely removes from the lower housing 12 of the conduit joint 1, and the action loop 14, the lower housing 12, and as the valve stem 114 moves toward the outer side of the lower housing 12 by using the first compression spring 113 at the time that the outer diameter of the bottom of the action loop 14 pushes the balls 122 to move outward, hence the balls 122 retain in the third chamfer 152 of the outer cover 15.

It can be clearly seen from the preceding accounts on the features of the present invention that the conduit joint for the refrigerant charging device of the present invention has the following advantages:

1. Before the engagement of the conduit joint 1 and the refrigerant feeding end 3, the outer cover 15 has not to be pulled upward by hands, thereby obtaining an easy operation.

2. The refrigerant in the refrigerant charging device can be fed into the air conditioning system from the refrigerant feeding end without leak.

While we have shown and described various embodiments in accordance with the present invention, it is clear to those skilled in the art that further embodiments may be made without departing from the scope of the present invention.

What is claimed is:

1. A conduit joint for a refrigerant charging device comprising:
an upper housing including a connection tube disposed on the outer wall thereof and extending outward, and a first chamber formed therein, a conduit connected between the connection tube and an outlet of the refrigerant charging device, and a first compression spring mounted in the fist chamber and its outer end being fitted into a valve stem;
a lower housing fitted on the bottom of the upper housing and including a second chamber fixed therein for communicating with the first chamber, and including a plurality of balls retained on the outer wall thereof;
a leakproof ring disposed in the second chamber of the lower housing and on the valve stem;
an action loop mounted in the second chamber and under the leakproof ring, wherein the action loop allows to push the balls outward by way of the leakproof ring;
an outer cover fitted around the lower housing, and between the outer cover and the lower housing is defined a second compression spring, wherein the outer cover is pushed to move upward due to the balls moves outwardly.

2. The conduit joint for the refrigerant charging device as claimed in claim 1, the vertical segment of the valve stem is inserted through the center of the leakproof ring.

3. The conduit joint for the refrigerant charging device as claimed in claim 1, wherein the lower end of the action loop allows to push the balls to move outward by way of the first compression spring.

4. The conduit joint for the refrigerant charging device as claimed in claim 1, wherein on the inner and outer walls of the bottom of the action loop are formed a first chamfer and a second chamfer respectively.

5. The conduit joint for the refrigerant charging device as claimed in claim 1, wherein on the outer wall of the lower housing where is located under the balls is attached a C-ring, outer diameter of which extends out of the outer wall of the lower housing.

6. The conduit joint for the refrigerant charging device as claimed in claim 1, wherein on the inner wall of the bottom of the outer cover is disposed a third chamfer.
